(19) United States
(12) Patent Application Publication
(10) Pub. No.: US 2015/0083617 A1
(43) Pub. Date: Mar. 26, 2015

(54) PACKAGING HAVING A MOVABLE INNER PACKET PART

(71) Applicants: Tim Collins, Surrey (GB); Bhanukiran Desiraju, Geneva (CH)

(72) Inventors: Tim Collins, Surrey (GB); Bhanukiran Desiraju, Geneva (CH)

(73) Assignee: JT INTERNATIONAL SA, Geneva (CH)

(21) Appl. No.: 14/398,419

(22) PCT Filed: May 1, 2013
(86) PCT No.: PCT/EP2013/059071

§ 371 Date: Oct. 31, 2014

(30) Foreign Application Priority Data
May 2, 2012 (EP) 12166478.3

(51) Int. Cl. B65D 85/10; B31B 1/26; B65D 5/32

(52) U.S. Cl. CPC B65D 85/1063; B65D 5/32; B31B 1/26
USPC 206/257; 206/273; 493/162

(57) ABSTRACT

There is provided packaging (1), and blanks for forming said packaging, which comprises an inner packet part (150) and an outer packet part (100). The inner packet part is movable relative to the outer packet part. Movement of the inner packet part (150) is limited by a flexible linking element (170) which extends between the inner packet part (150) and the outer packet part (100).

### FIELD OF THE INVENTION

The present invention generally relates to the field of packaging, particularly for tobacco products. More particularly, the present invention relates to a new type of cigarette packaging, and blanks used in the construction of such packaging.

### BACKGROUND TO THE INVENTION

There is an ongoing desire to improve packaging, and in particular packaging for consumer products. Such improvements must take account of the simultaneous, and sometimes competing, requirements of cost and quality. Particular restrictions are apparent when the packaging must be mass produced, as is often the case for consumer packaging.

One area in which these difficulties are apparent is in the production of packaging for tobacco products, such as cigarettes. Packaging for this purpose is placed under a number of particular stresses. Typically formed from cardboard blanks in order to facilitate mass production, the packaging is often carelessly handled and stored. Furthermore, the packaging must be able to withstand repeated openings and closures.

Perhaps the most common design of packaging for cigarettes can be characterised as a hinged lid pack. In this design, an upper portion of the packaging acts as a lid which is hinged to the body of the pack at the rear.

Although the hinged lid pack is relatively cheap to produce and is relatively robust when in a closed position, the lid itself is prone to damage when open and during the opening process. For example, the fold line connecting the body of the pack to the lid can be prone to tearing when the lid is not properly closed. There is also a risk of accidental opening of the lid as the packaging is removed from storage in, for example, the pocket.

In addition, there is a general desire to provide packaging which provides a more satisfying user experience. Even when undamaged, the hinged lid pack requires two hands to open, one to hold the body and one to grip the lid. Moreover, there is no cue given to the user to indicate the action of opening the packaging is complete.

In view of the above, efforts have been made to develop alternative designs for cigarette packaging. Some examples of such alternative comprise an inner packet part disposed within an outer packet part. The inner packet part is provided with an opening through which the user may access cigarettes and is movable relative to the outer packet part between a closed position and an open position. When the inner packet part is in the closed position, the opening is concealed by the outer packet part, while the opening is revealed when the outer packet part is moved to an open position.

The movement of the inner packet part between the closed and open positions may comprise a rotational element, so that the inner packet part “swings” out from the outer packet part. Alternatively, the movement may be linear, causing a “sliding” motion. In such “swing” or “slide” packs, it is important that some restraint is placed on the movement of the inner packet part, so that it does not progress beyond the open position, since this may lead to cigarettes being accidentally dropped.

This restraint is typically achieved by interlocking tabs provided on the inner packet part and the outer packet part. As the inner packet part opens, a tab on the inner packet part is received behind a corresponding tab or flap on the outer packet part, preventing further movement beyond a defined open position. However, this mechanism may suffer from damage to the tabs themselves through repeated use, or failure of the tabs to engage.

There is an ongoing desire to improve the design of packaging to enable an improved user experience. Simultaneously, it remains desirable that packaging is both durable and relatively cheap to produce.

### SUMMARY OF THE INVENTION

According to a first aspect of the present invention, there is provided packaging, comprising: an outer packet part; An inner packet part disposed within the outer packet part, wherein the inner packet part is movable relative to the outer packet part between a closed position and an open position through an opening in the outer packet part; and a flexible linking element extending from the inner packet part to the outer packet part, wherein the flexible linking element is arranged to limit movement of the inner packet part relative to the outer packet part.

The present invention can prevent unwanted or excessive opening of the inner packet part by the provision of a linking element. The linking element extends between the inner packet part and the outer packet part, so that the inner packet part cannot go beyond a position at which the linking element is pulled tight. Since the linking element may be permanently connected to both the inner and outer packet parts, this mechanism does not suffer the risk that a failure to engage will allow the inner packet part to open excessively. Moreover, since the linking element is flexible it can be arranged such that its shape varies as the inner packet part moves. This allows the linking element to, for example, fold around the inner packet part when in the closed position, meaning that the linking element does not unduly limit the potential structure of the inner packet part itself or require additional space to be provided within the outer packet part.

An additional advantage of providing a linking element that does not rely on tabs or similar constructions in the faces of the inner or outer packet parts is that the space that would be taken up by such elements remains available for other purposes.

Preferably, movement of the inner packet part between the closed position and the open position comprises rotational movement. For example, the inner packet part may rotate around an axis of rotation. In other examples, movement of the inner packet part may comprise linear movement or a combination of linear and rotational movement. Rotational movement finds particular utility in providing access to users for the contents within the inner packet part, and also provides a pleasant action for the user. Rotational movement can also be used to allow the inner packet part to move away from two adjacent faces of the outer packet part, creating more room for the action or rotation of the linking element. Indeed, it is generally preferable that the movement comprises components perpendicular to at least two faces of the outer packet part, in order to provide suitable space for the movement of the linking element.

In preferred embodiments, the movement of the inner packet part between the closed position and the open position comprises rotational movement around an axis which is inset from an outer side face of the inner packet part, the outer side face being disposed towards the opening of the outer packet part when the inner packet part is in the closed position. Accordingly, as the inner packet part rotates towards the open position, an outer side of the inner packet part moves downwardly relative to the inner packet part. This allows for the production of compact packaging, as it reduces the requirement for additional room within the outer packet part to accommodate the rotation of the inner packet part.

In preferred embodiments, the linking element is arranged such that it extends from the outer packet part away from the opening when the inner packet part is in the closed position and extends from the outer packet part towards the opening when the inner packet part is in the open position. Accordingly, the linking element moves between two different orientations as the inner packet part moves between the open and closed positions. In this manner, the linking element can be conveniently stored when the inner packet part is in the closed position.

Preferably, the linking element is coupled to an inner side face of the inner packet part, the inner side face being disposed away from the opening of the outer packet part when the inner packet part is in the closed position.

Furthermore, the linking element is preferably coupled to a top face of the outer packet part. In a particularly preferred embodiment, the linking element extends from an inner side face of the inner packet part to the top face of the outer packet part above an upper end of the inner packet part. As the inner packet part is moved outwardly from the closed position to the open position, the linking element may rotate in the space within the outer packet part left behind the inner packet part. First, the linking element is pulled downwardly into this space, and is then pulled outwardly behind the inner packet part until it reaches its full length, at which points it limits movement of the inner packet part beyond this point.

To facilitate this process, it is preferable that, when the inner packet part is in the closed position, the linking element is coupled to the inner side face at a position disposed away from a connecting face of the outer packet part to which the linking element is coupled. This arrangement assists in enabling the linking element to be pulled down behind the inner packet part as it is moved from the closed position to the open position. The connecting face may be the top face, as mentioned above, but may also in alternative embodiments be another face, such as a front face, rear face, or bottom face. Preferably, the connecting face is substantially normal to the inner side face of the inner packet part.

In preferred embodiments, the linking element comprises a plurality of connecting sections hingedly coupled to one another to obtain an articulated linking element. These different sections provide controlled flexibility in the linking element, enabling it to flow a defined path as the inner packet part is moved between the closed and open positions. Preferably, when the inner packet part is in the closed position, at least one connecting section extends parallel to the connecting face of the outer packet part and at least one connecting section extends parallel to the inner side face of the inner packet part. In particular, a connecting section extending from the inner side face preferably extends parallel to the inner side face when the inner packet part is in the closed position. Furthermore, a connecting section extending from the connecting face of the outer packet part preferably extends parallel to the outer packet part when the inner packet part is in the closed position. In particularly preferred embodiments, when the inner packet part is in the closed position, at least two connecting sections extend parallel to the connecting face of the outer packet part. This arrangement has been found to be particularly effective in enabling a compact and robust design in which the linking element may rotate. Further, due to the configuration of the connecting sections as described above, i.e. at least two connecting sections extend parallel to the connecting face of the outer packet part and at least one connecting section extends parallel to the inner side face of the inner packet part, a staged opening effect may be achieved as the inner packet part is moved from a closed position to an open position.

It should be understood that starting from the connecting section extending parallel to the inner side face of the inner packet part and moving along the articulated linking element, the connecting sections will be referred to hereinafter as the first, second and third connecting sections respectively. For example, a first stage of the staged opening effect may be defined between the closed position of the inner packet part and the point at which the plane of the inner side face passes the hinge between the second and third connecting sections. Subsequently, a second stage of the staged opening effect may be defined between the point at which the plane of the inner side face passes the hinge between the second and third connecting sections and the open position of the inner packet part. At the first stage, as the inner packet part is moved from the closed position towards the open position, the second connecting section may rotate about the hinge between the second and third connection sections, whilst the third connecting section remains substantially parallel to the connecting face of the outer packet part. At the second stage, the third connecting section may rotate about the hinge between the third connecting section and the top face of the outer packet part. This configuration advantageously creates a smooth but robust staged opening effect to the user.

Preferably, the linking element is integrally formed with the inner packet part. For example, the linking element and the inner packet part may be formed from a single blank. By avoiding the need for additional independent features in the packaging, preferred embodiments can avoid incurring additional manufacturing costs.

In preferred embodiments, the outer packet part comprises a hinged tab, and the inner packet part is mounted to the hinged tab. Preferably, the hinged tab is coupled to a base of the inner packet part. While the linking element can limit the movements of the inner packet part, the hinged tab can at least partly define the path over which that movement occurs. As mentioned above, such a path may, for example, comprise a rotational element. It should be understood that the hinged tab may also be referred to as the hinged flap.

The hinged tab may or may not be folded over the base of the outer packet part when the inner packet part is in the closed position.

In arrangements in which the inner packet part may move rotationally, an axis of rotation may be aligned with a side face of the inner packet part, or may be offset from the side faces. In a preferred embodiment, the axis of rotation is offset from the side faces. Thus, as the inner packet part rotates, at least a part of it will first rise relative to the outer packet part before falling once it passes over the axis of rotation.

In a preferred embodiment, the effect of at least a part of the inner packet part first rising relative to the outer packet part before falling once it passes over the axis of rotation is caused by the fact that said axis is offset from the side faces of the inner packet part, and this effect is used in order to provide intermittent frictional resistance to the movement of the inner packet part between the open and closed positions. In alternative embodiments, another means may be provided to introduce intermittent resistance to movement of the inner packet part. Accordingly, the inner packet part may be arranged such that, during movement between the closed position and the open position, it undergoes intermittent resistance. Accordingly, the user experiences the opening process in two stages, a first stage up to the point of frictional resistance, and a second stage beyond this, although these two stages are not equivalent to the stages resulting from the configuration of the connecting sections as described above. This provides positive tactile feedback to the user and a sensation of quality and robustness of the pack. It should be understood that this two stage opening effect may act in replacement of or complementary with the staged opening effect due to the configuration of the connecting sections.

In preferred embodiments, the inner packet part comprises at least one opening in an upper face to allow access to a product in the inner packet part, wherein the opening is concealed by the outer packet part when the inner packet part is in the first position. Accordingly, the first position is a closed position in which access to the product is not possible. In the second, open position, the outer packet part does not conceal the opening.

Preferably, the opening of the inner packet part extends into at least one side of the inner packet part. This arrangement further facilitates user access to products within the inner packet part.

Preferred embodiments of the present invention comprise a plurality of inner packet parts. Preferably, a plurality of flexible elements are provided such that each inner packet part is associated with at least one flexible linking element. The flexible linking elements of the present invention find particular utility when multiple inner packet parts are provided, since each inner packet part must be smaller than the outer packet part. This increases the risk on unreliability in conventional means for limiting movement of the inner packet part, and further means that space within the outer packet part is at a greater premium.

In preferred embodiments, the inner packet part and the outer packet part are each obtained from a single foldable blank of paper, cardboard, plastic material or a combination thereof. Indeed, the present invention further encompasses blanks for use in the production of the inner packet part and the outer packet part. Furthermore, the invention comprises a method for forming the inner packet part or the outer packet part from such blanks.

### BRIEF DESCRIPTION OF THE FIGURES

FIG. 1A shows packaging according to a preferred embodiment in which inner packet parts are disposed in a closed position within an outer packet part;

FIG. 1B shows the preferred embodiment when the inner packet parts are in an open position;

FIG. 2A shows a blank from which the outer packet part of the preferred embodiment may be formed;

FIG. 2B shows blanks from which the inner packet parts of the preferred embodiment may be formed;

FIG. 3A shows a detailed view of the top of the packaging when an inner packet part is in a closed position;

FIG. 3B shows a detailed view of the top of the packaging when the inner packet part is in a first intermediate position between the closed position and an open position;

FIG. 3C shows a detailed view of the top of the packaging when the inner packet part is in a second intermediate position between the closed position and the open position; and

FIG. 3D shows a detailed view of the top of the packaging when the inner packet part is in the open position.

### DETAILED DESCRIPTION

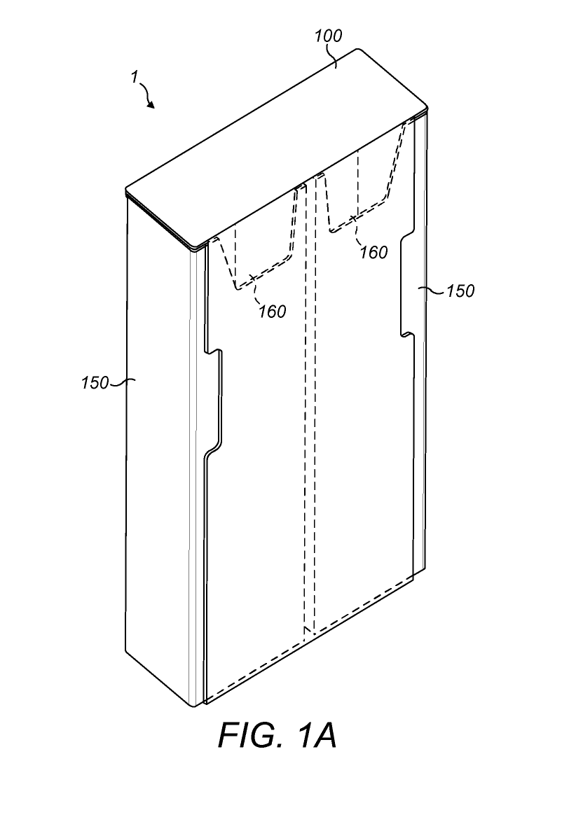

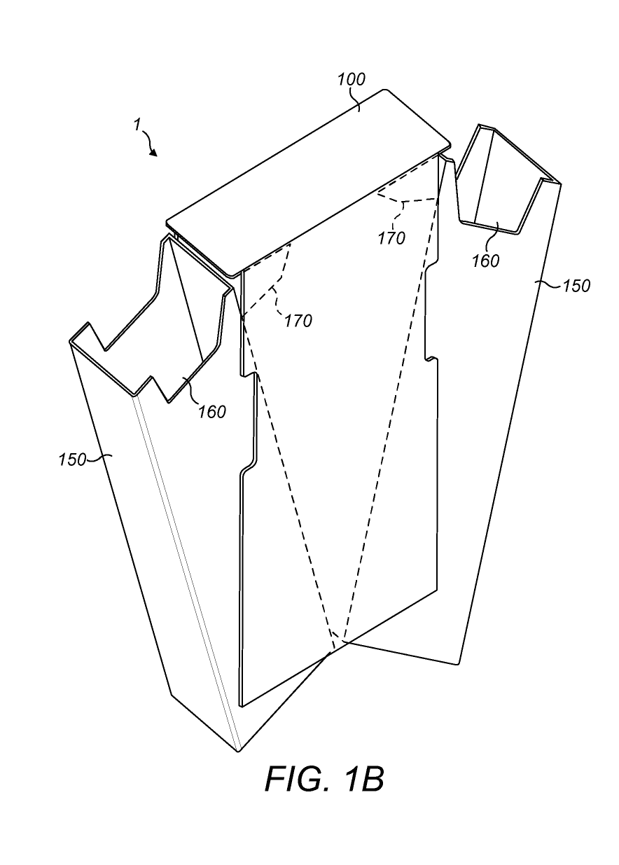

Packaging 1 according to a preferred embodiment of the present invention is illustrated in FIGS. 1A and 1B. The packaging comprises an outer packet part 100 and two inner packet parts 150. Each inner packet part 150 is independently movable relative to the outer packet part 100 between a closed position and an open position.

The packaging 1 of the preferred embodiment is used to store tobacco products. In particular, the packaging 1 is preferably packaging for cigarettes. Although not shown in the Figures, the cigarettes are disposed longitudinally within the packaging, allowing a user to retrieve them from an inner packet part 150 when it is in an open position.

In FIG. 1A, the inner packet parts 150 are shown in their closed positions, while in FIG. 1B the inner packet parts 150 are in their open positions. The inner packet part 150 comprises an opening 160 which allows user access to the products within the packaging, which in preferred examples may be cigarettes. In the closed position shown in FIG. 1A, it can be seen that the opening 160 is concealed by the outer packet part 100. As such, the user is unable to access the products when the inner packet parts 150 are in the closed position. In contrast, when the inner packet parts 150 are rotated to the open position, as shown in FIG. 1B, the opening 160 is accessible to the user, allowing access to the product. It will be appreciated that although both inner packet parts 150 have been rotated to the open position in FIG. 1B, they are operated independently of one another. As such, the inner packet parts 150 may be in different positions at a given time.

The inner packet parts 150 further comprise a linking element 170 which is fixed to a top face of the outer packet part 100. The top face of the outer packet part 100 thus acts as a connecting face for the linking element 170. The linking element 170 prevents movement of the inner packet parts 150 beyond the open position. The inner packet parts 150 are also coupled to the outer packet part 100 at its base, and in particular are mounted on a hinged flap of the outer packet part 100. The hinged flap is arranged to rotate around a position disposed inwardly from the side faces of the packaging 1. As such, as the inner packet parts 150 rotate outwardly towards the open position, the outer side faces and bottom corners of the inner packet parts 150 move downwardly relative to the outer packet part 100 and below the level of the bottom face of the outer packet part 100. The configuration allows the overall size, and particularly the height, of the packaging 1 to be the same as a conventional cigarette pack, often known as a crush-proof box.

The linking element 170 is flexible. As such, its shape can be altered during movement of the inner packet part 150 between the open position and the closed position. In this embodiment, this allows the linking element 170 to be folded around the inner packet part 150 when the inner packet part 150 is in the closed position, and as such does not require additional space to be provided in the outer packet part 100.

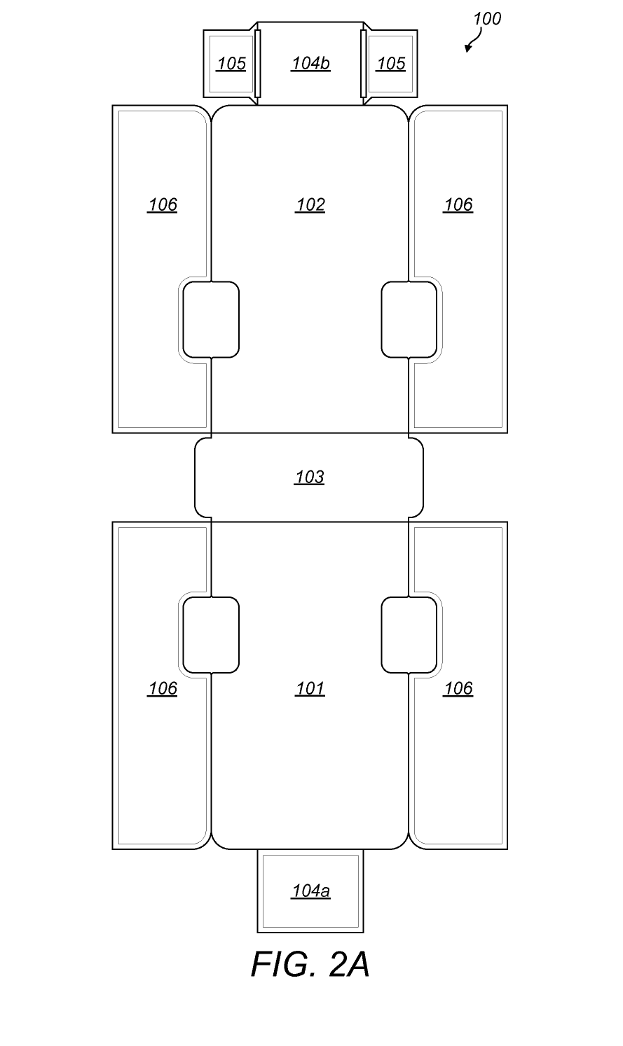

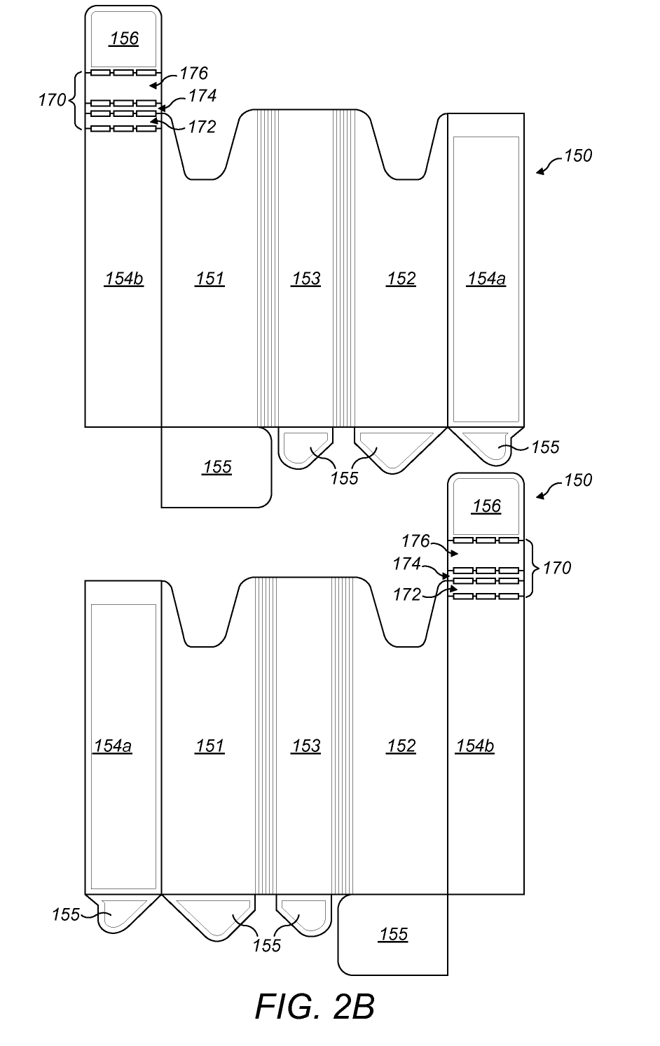

The construction of the inner and outer packet parts may be further understood with reference to FIGS. 2A and 2B, which illustrate blanks for the production of the outer packet part 100 and the inner packet parts 150 respectively.

Referring to FIG. 2A, the outer packet part 100 comprises a front face 101 and a rear face 102. A top face 103 is provided between the front face 101 and the rear face 102. The bottom face 104 comprises a first bottom face part 104a formed integrally with the front face 101 and a second bottom face part 104b formed integrally with the rear face 102. Hinged flaps 105 are provided connected to the second bottom face part 104b. The outer packet part 100 further comprises reinforcing tabs 106 extending from the side edges of the front face 101 and the rear face 102.

When formed, the outer packet part 100 is folded such that the front face 101 and the rear face 102 oppose each other. The top face 103 extends between and perpendicular to the front face 101 and the rear face 102. The bottom face 104, which also extends between and perpendicular to the front face 101 and the rear face 102, is formed by gluing the first bottom face part 104a to a lower surface of the second bottom face part 104b. The hinged flaps 105 are left free to rotate relative to the bottom face 104. The bottom face 104 does not extend the entire width of the outer packet part 100. As a result, the hinged flaps 105 rotate around an axis inset from the openings in the sides of the outer packet part 100. In the preferred embodiment, each axis is inset by approximately a quarter of the width of the outer packet part 100 (and thus half the width of the inner packet parts 150). The inner packet 150 part is then glued to the hinged flaps 105. The reinforcing tabs 106 are folded inwardly and glued to inner surfaces of the front face 101 and the rear face 102.

FIG. 2B illustrates blanks for forming the inner packet parts 150. Each inner packet part comprises a front face 151 and a rear face 152. There is further provided an outer side face 153 between the front face 151 and the rear face 152. An inner side face 154 is formed of first inner side face part 154a and second inner side face part 154b. A bottom face of the inner packet part 150 is formed from bottom face tabs 155.

The linking element 170 extends from the second inner face part 154b. The linking element 170 comprises thee substantially planar connecting sections, referred to hereinafter as a first connecting section 172, a second connecting section 174, and a third connecting section 176. Fold lines between connecting sections 172, 174, 176 allow relative rotation of each section as the inner packet part 150 is rotated between the closed position and the open position. In this manner, the linking element 170 is flexible, and in particular in the preferred embodiment is precisely articulated between each of the connecting sections 172, 174, 176, even though the connecting sections are themselves substantially rigid. A mounting tab 156 is formed at the end of the third connecting section 176. The articulated structure of the linking element 170 not only provides flexibility to the linking element 170 but also guides the course of the inner packet part 150 during opening and closing motions relative to the outer packet part 100 without increasing the overall size (height and width particularly) of the packaging 1 compared to a regular crush-proof cigarette pack.

When the inner packet parts 150 are formed, the blanks are folded such that the front face 151 and the rear face 152 oppose each other. The outer side face 153 extends between the front face 151 and the rear face 152, while the inner side face 154 also extends between the front face 151 and rear face 152 and is formed by gluing first inner side face part 154a to second inner side face part 154b. A bottom face is formed by gluing bottom face tabs 155 to each other. The bottom face is itself glued to a hinged flap 105 of the outer packet part 100.

The linking element 170 extends from the top edge of the inner side face 154. The linking element 170 extends from a position below the top edge of the front and rear faces 151, 152 by setting the length of the first connecting section 172 to approximately the distance between the top edge of the inner side face 154 and that of the front and rear faces 151, 152.

The mounting tab 156 is glued to an inner surface of the top face 103 of the outer packet part 100, and in particular is connected towards an outer edge of the top face 103. Accordingly, when the inner packet part 100 is in the closed position, as illustrated in FIG. 1A, the linking element 170 extends inwardly from its connection to the top face via the mounting tab 156 across an upper end of the inner packet part 150.

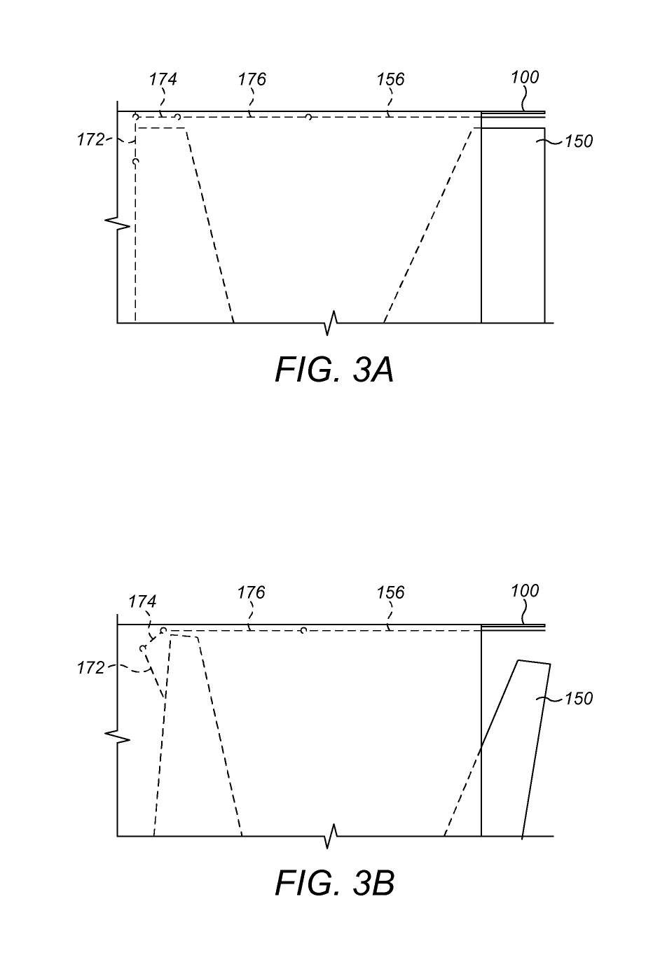

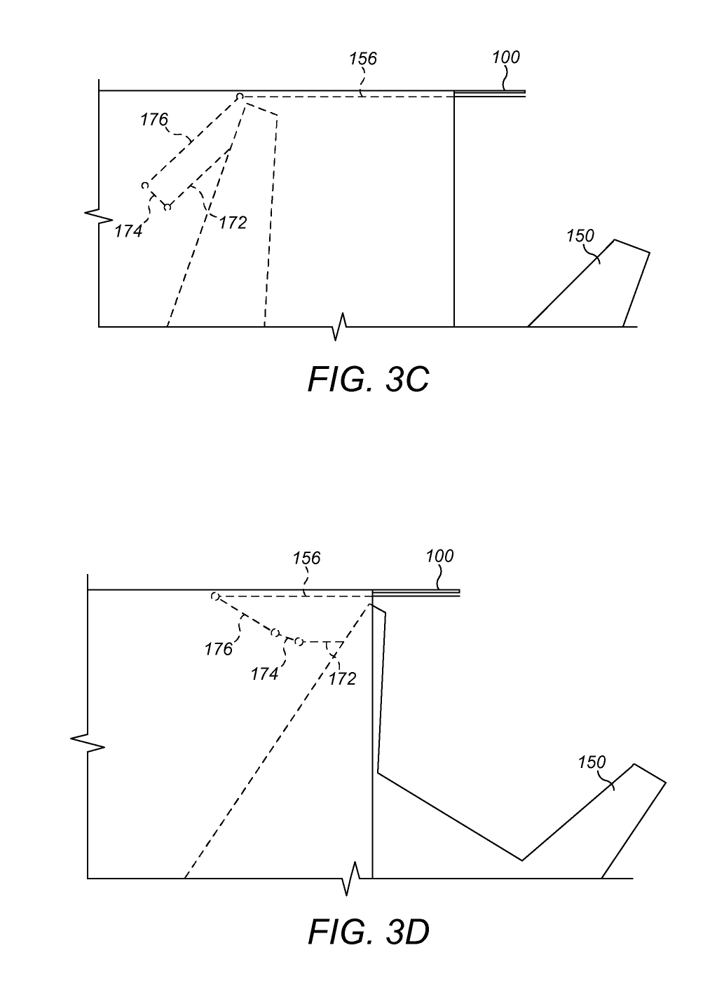

The operation of the linking tab 170 can be further understood from FIGS. 3A to 3D, which show an expanded view of the top of the packaging 1 as an inner packet part 150 is moved from the closed position to the open position.

In FIG. 3A, the inner packet part 150 is in the closed position. In this position, the first connecting section 172 extends upwardly from the inner side face of the inner packet part 150, while the second connecting section 174 and the third connecting section 176 extend horizontally across the top of the inner packet part 150 to the mounting tab 156.

As the inner packet part 150 is moved towards the open position, it reaches the position shown in FIG. 3B. At this point, the second connecting section 174 is pulled downwardly by the action of the first connecting section 172 which is pulled across by the inner packet part 150. The third connecting section 176 remains above the inner packet part 150 against the top face 103 of the outer packet part 100. As the inner packet part moves between the positions illustrated by FIGS. 3A and 3B respectively, this may be considered a first stage of opening that is provided to the user due to the configuration of the connecting sections.

The inner packet part 150 then proceeds further until it reaches the position shown in FIG. 3C. At this point, the third connecting section 176 has been pulled downwardly by the second connecting section 174. Accordingly, only the mounting tab 156 remains disposed against the top face of the outer packet part 100 at this point. As the inner packet part moves between the positions illustrated by FIGS. 3B and 3C respectively, and subsequently to the position illustrated by FIG. 3D, this may be considered a second stage of opening that is provided to the user due to the configuration of the connecting sections.

It will be understood that as the inner packet part 150 rotates, the inner side face 154 of the inner packet part 150 will be raised upwardly (i.e. towards the top face of the outer packet part 100) until it is directly above the axis around which the hinged flap 105 and inner packet part rotates (i.e. the fold line between the bottom face 154 of the outer packet part 100 and the hinged flap 105 upon which the inner packet part 150 is mounted). Since this axis is inset from the outer side face 153 of the inner packet part 150, the outer side face 153 moves downwardly during this phase, and after this point the inner side face of the inner packet part 150 will also move downwardly away from the top face 103 of the outer packet part 100. As a result, by moving the axis of rotation away from the opening of the outer packet part 100, there is a reduced need for space in the packaging above the inner packet part 150. The need for space in the outer packet part 100 to accommodate the upward motion of the inner side face 154 of the inner packet part 150 is also reduced by the provision of multiple inner packet parts 150, since this reduces the width of each inner packet part 150. In the preferred embodiment, the inner face of the inner packet part 150 is at its highest point in the position shown in FIG. 3C.

At this point, the front and rear faces 151, 152 of the inner packet part touch the mounting tab 156, creating friction which must be overcome if the inner packet part 150 is to move further. This creates an additional two stage opening effect for the user, who may easily rotate the packing to the position shown in FIG. 3C, but must apply further force to rotate the inner packet part 150 further. It will be understood that the two stages of this two stage opening effect are not equivalent to the stages resulting from the configuration of the connecting sections as described above. In addition, this additional two stage opening effect advantageously prevents self-opening of the inner packet part upon tilting of the packaging.

FIG. 3D shows the inner packet part 150 when it is fully rotated to the open position. At this point, the three connecting sections 172, 174, 176 of the linking element 170 are all disposed in substantially the same direction. Although the linking element is not fully extended in the arrangement shown in FIG. 3D, it can be clearly understood that the further rotation of the inner packet part 150 is limited by the linking element 170, since it is fixed to the outer packet part 100 via the mounting tab 156.

To close the packaging, the user rotates the inner packet part 150 from the position shown in FIG. 3D to the position shown in FIG. 3A through the positions shown in FIGS. 3C and 3B. Again, as the inner packet part 150 passes through the position shown in FIG. 3C, friction with the mounting tab 156 provides resistance, leading to a two stage motion (i.e. a first stage prior to this point, and a second state after this point). This provides a reassuring sensation for the user, who is given tactile feedback that the closing action has correctly occurred. The user's impression of the quality of the packaging, and by extension the products within, is thus improved.

The above description refers to a particularly preferred embodiment. However, the skilled person will recognise that variations and modifications can be applied as appropriate. For example, while the above embodiment provides two inner packet parts 150, other embodiments may comprise a single inner packet part or any other number of inner packet parts. The invention can also be contemplated with sliding-only inner packet parts.

Similarly, while the packaging of the above-described embodiment is designed for tobacco products, and particularly for cigarettes, other products may be provided within the inner packet part. Furthermore, the skilled person may modify or alter the particular geometry and arrangement of the particular features of the packaging.

Other variations and modifications will also be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination.

1. A packaging, comprising:
an outer packet part;
an inner packet part disposed within the outer packet part, wherein the inner packet part is movable relative to the outer packet part between a closed position and an open position through an opening in the outer packet part;
and a flexible linking element extending from the inner packet part to the outer packet part,
wherein the flexible linking element is arranged to limit movement of the inner packet part relative to the outer packet part.

2. The packaging according to claim 1, wherein movement of the inner packet part between the closed position and the open position comprises rotational movement.

3. The packaging according to claim 2, wherein the movement of the inner packet part between the closed position and the open position comprises rotational movement around an axis which is inset from an outer side face of the inner packet part, the outer side face being disposed towards the opening of the outer packet part when the inner packet part is in the closed position.

4. The packaging according to claim 3, wherein the linking element is arranged such that it extends from the outer packet part away from the opening when the inner packet part is in the closed position and extends from the outer packet part towards the opening when the inner packet part is in the open position.

5. The packaging according to claim 4, wherein the linking element is coupled to an inner side face of the inner packet part, the inner side face being disposed away from the opening of the outer packet part when the inner packet part is in the closed position.

6. The packaging according to claim 5, wherein the linking element is coupled to a top face of the outer packet part.

7. The packaging according to claim 6, wherein, when the inner packet part is in the closed position, the linking element is coupled to the inner side face at a position disposed away from a connecting face to which the linking element is coupled.

8. The packaging according to claim 7, wherein the linking element comprises a plurality of connecting sections hingedly coupled to one another.

9. The packaging according to claim 8, wherein, when the inner packet part is in the closed position, at least one connecting section extends parallel to a connecting face of the outer packet part to which the linking element is coupled and at least one connecting section extends parallel to the inner side face of the inner packet part.

10. The packaging according to claim 9, wherein, when the inner packet part is in the closed position, at least two connecting sections extend parallel to the connecting face of the outer packet part.

11. The packaging according to claim 10, wherein the inner packet part is arranged such that, during movement between the closed position and the open position, it undergoes intermittent resistance.

12. A blank for forming the inner packet part of claim 1.

13. A blank for forming the outer packet part of claim 1.

14. A method of forming an inner packet part, comprising folding the blank of claim 12.

15. A method of forming an outer packet part, comprising folding the blank of claim 13.

16. The packaging according to claim 1, wherein the linking element is arranged such that it extends from the outer packet part away from the opening when the inner packet part is in the closed position and extends from the outer packet part towards the opening when the inner packet part is in the open position.

17. The packaging according to claim 1, wherein the linking element is coupled to an inner side face of the inner packet part, the inner side face being disposed away from the opening of the outer packet part when the inner packet part is in the closed position.

18. The packaging according to claim 1, wherein the linking element is coupled to a top face of the outer packet part.

19. The packaging according to claim 1, wherein, when the inner packet part is in the closed position, the linking element is coupled to the inner side face at a position disposed away from a connecting face to which the linking element is coupled.

20. The packaging according to claim 1, wherein the linking element comprises a plurality of connecting sections hingedly coupled to one another.
